(19) United States
(12) Patent Application Publication
(10) Pub. No.: US 2024/0313854 A1
(43) Pub. Date: Sep. 19, 2024

(54) PAGING IN DISCONTINUOUS COVERAGE

(71) Applicant: QUALCOMM Incorporated, San Diego, CA (US)

(72) Inventors: Bharat SHRESTHA, San Diego, CA (US); Mungal Singh DHANDA, Slough (GB); Umesh PHUYAL, San Diego, CA (US); Amer CATOVIC, San Diego, CA (US); Luis Fernando Brisson LOPES, Swindon (GB); Haris ZISIMOPOULOS, London (GB); Alberto RICO ALVARINO, San Diego, CA (US); Ayan SENGUPTA, San Diego, CA (US)

(21) Appl. No.: 18/575,237

(22) PCT Filed: Aug. 1, 2022
(86) PCT No.: PCT/US2022/074366

§ 371 Date: Dec. 28, 2023

(30) Foreign Application Priority Data
Aug. 4, 2021 (GR) 20210100534

(51) Int. Cl. H04B 7/185; H04W 68/02

(52) U.S. Cl. CPC H04B 7/1853; H04W 68/02

(57) ABSTRACT

Certain aspects of the present disclosure provide techniques for paging in discontinuous coverage. A method that may be performed by a network entity includes communicating with a user equipment (UE) and a core network: and sending or receiving radio paging information indicating at least one of cell coverage information or an identifier associated with a geographic area in which the UE is located, wherein the geographic area is in a coverage path of a non-terrestrial network (NTN).

### CROSS-REFERENCE TO RELATED APPLICATION

This application claims priority to Greek patent application Ser. No. 20210100534, filed Aug. 4, 2021, which is herein incorporated by reference in its entirety for all applicable purposes.

### INTRODUCTION

Aspects of the present disclosure relate to wireless communications, and more particularly, to techniques for communicating with a UE in discontinuous coverage.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method of wireless communication by a network entity. The method generally includes communicating with a user equipment (UE) and a core network; and sending or receiving radio paging information indicating at least one of cell coverage information or an identifier associated with a geographic area in which the UE is located, wherein the geographic area is in a coverage path of a non-terrestrial network (NTN).

One aspect provides a method of communication by a core network. The method generally includes communicating with a user equipment (UE) and a network entity; and sending or receiving radio paging information indicating at least one of cell coverage information or an identifier associated with a geographic area in which the UE is located, wherein the geographic area is in a coverage path of a non-terrestrial network (NTN).

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a base station and user equipment.

FIGS. 3A-3D depict various example aspects of data structures for a wireless communication network.

FIG. 4 is a diagram illustrating an example wireless communication network having a non-terrestrial network entity.

FIG. 5 is a diagram illustrating an example of discontinuous coverage of a non-terrestrial network.

FIG. 6 is a signaling flow diagram illustrating example signaling for paging a user equipment in discontinuous coverage.

FIG. 7 is a flow diagram illustrating an example method for wireless communications by a network entity to page a user equipment in discontinuous coverage.

FIG. 8 is a flow diagram illustrating an example method for communications by a core network to page a user equipment in discontinuous coverage.

FIG. 9A depicts an example radio paging information message that includes a virtual cell identifier field.

FIG. 9B depicts an example radio paging information message that includes a zone identifier field.

FIG. 9C depicts an example radio paging information element that includes a discontinuous coverage capability field

FIG. 10 depicts aspects of an example communications device.

FIG. 11 depicts aspects of an example communications device.

### DETAILED DESCRIPTION

Aspects of the present disclosure provide apparatuses, methods, processing systems, and computer-readable mediums for paging in discontinuous coverage.

In certain cases, a non-terrestrial network (NTN) may provide discontinuous radio coverage to a user equipment (UE), for example, due to the orbit of NTN satellites. For example, some NTNs (such as a low Earth orbit (LEO) systems) may have one or more revisit times (which may also be known as the response time or coverage gap) in certain geographical areas. The revisit time may be the duration between consecutive viewings (or coverage areas) of a given location for an NTN. As an example, the satellite revisit time (or coverage gap) could be 10 to 40 minutes depending on the number of satellites deployed. The UE may be unreachable by the wireless network (such as the core network) during the revisit time. During the coverage gap, the UE and/or network may attempt to reconnect or communicate with each other. Such operations during the coverage gap may be inefficient for power consumption, especially at the UE, and/or for signaling overhead (e.g., affecting spectral efficiency) at the radio access network.

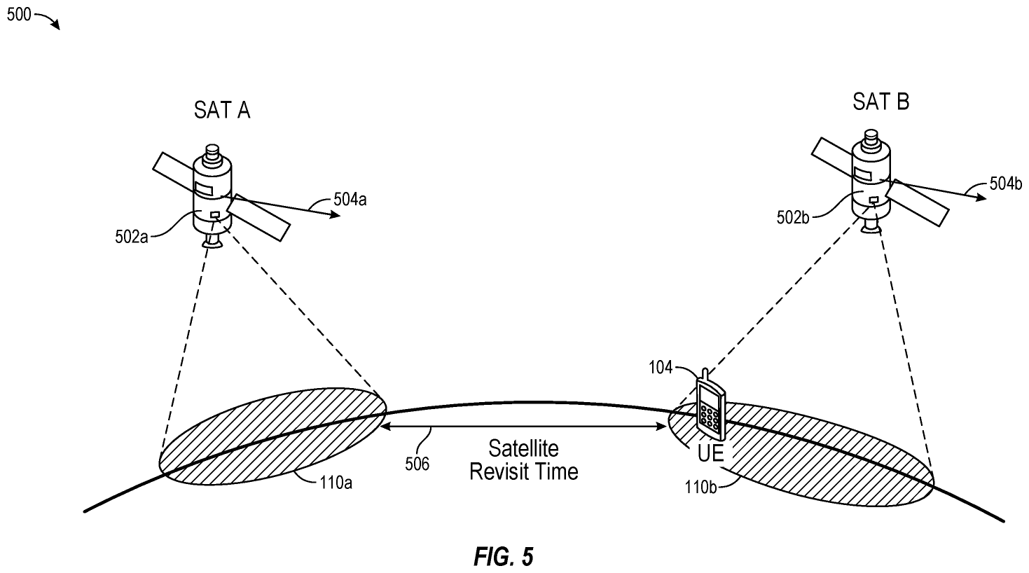

In certain aspects, a base station may receive from a UE or send to a core network paging assistance information that indicates a geographic area in which the UE is located, where the geographic area is in a coverage path of a NTN, which may have discontinuous coverage, for example, as described herein with respect to FIG. 5. The base station or core network may use the paging assistance information to take (perform) various actions to page the UE when the UE is in coverage with the NTN. In certain aspects, the base station and/or core network may delay the paging to the UE until the UE is in coverage with the NTN, as further described herein.

The techniques for paging the UE described herein may enable the network to successfully page a UE in discontinuous coverage, for example, due to the network paging the UE when the UE is in coverage with a cell. The techniques for paging the UE described herein may provide spectral efficiencies, for example, due to the network refraining from paging the UE until the UE is in coverage with a cell.

### Introduction to Wireless Communication Networks

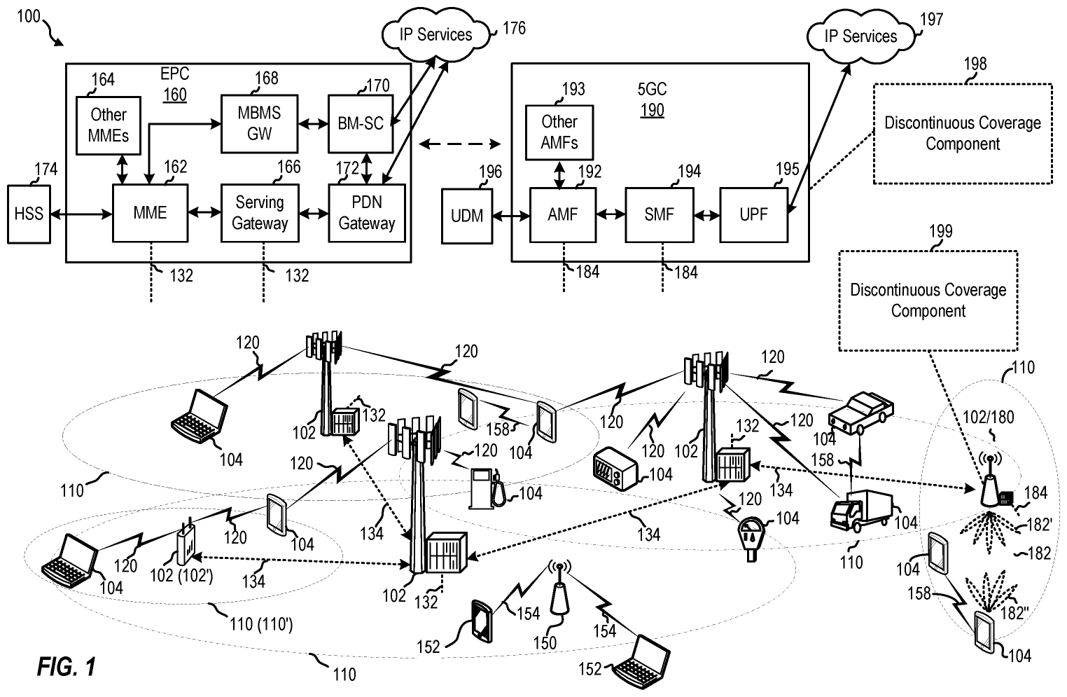

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190 (which may be generally referred to as a core network 190), which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes discontinuous coverage component 199, which may be configured to delay paging to a UE in discontinuous coverage and/or inform a core network of the paging delay, as further described herein. Wireless network 100 further includes discontinuous coverage component 198, which may be configured to delay paging to a UE and/or inform a base station of the paging delay, as further described herein.

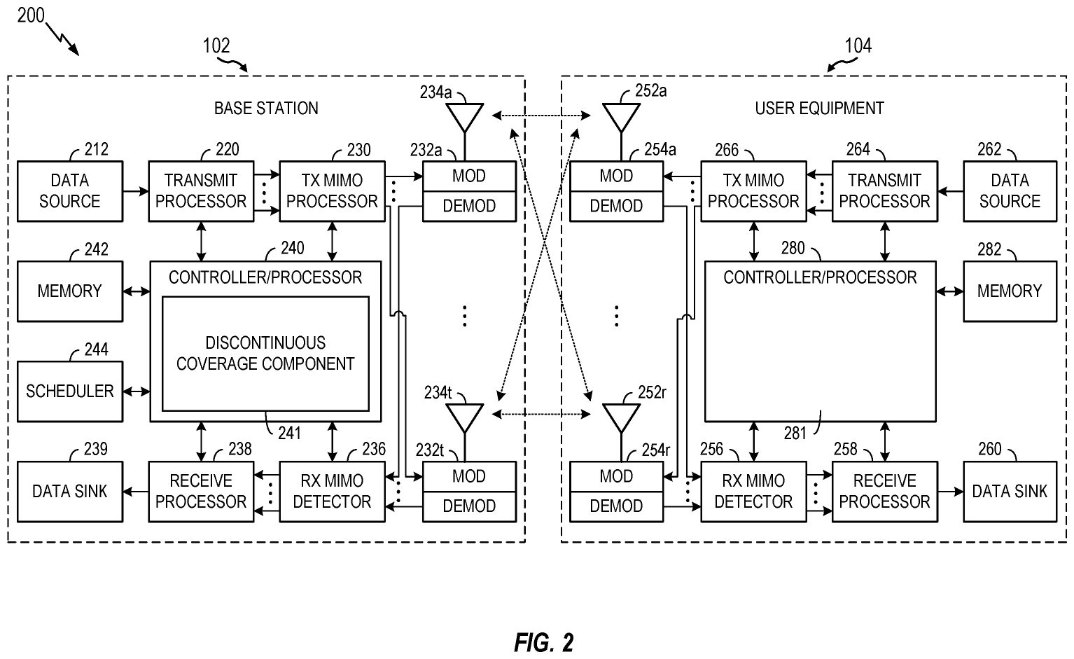

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes discontinuous coverage component 241, which may be representative of discontinuous coverage component 199 of FIG. 1. Notably, while depicted as an aspect of controller/processor 240, discontinuous coverage component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

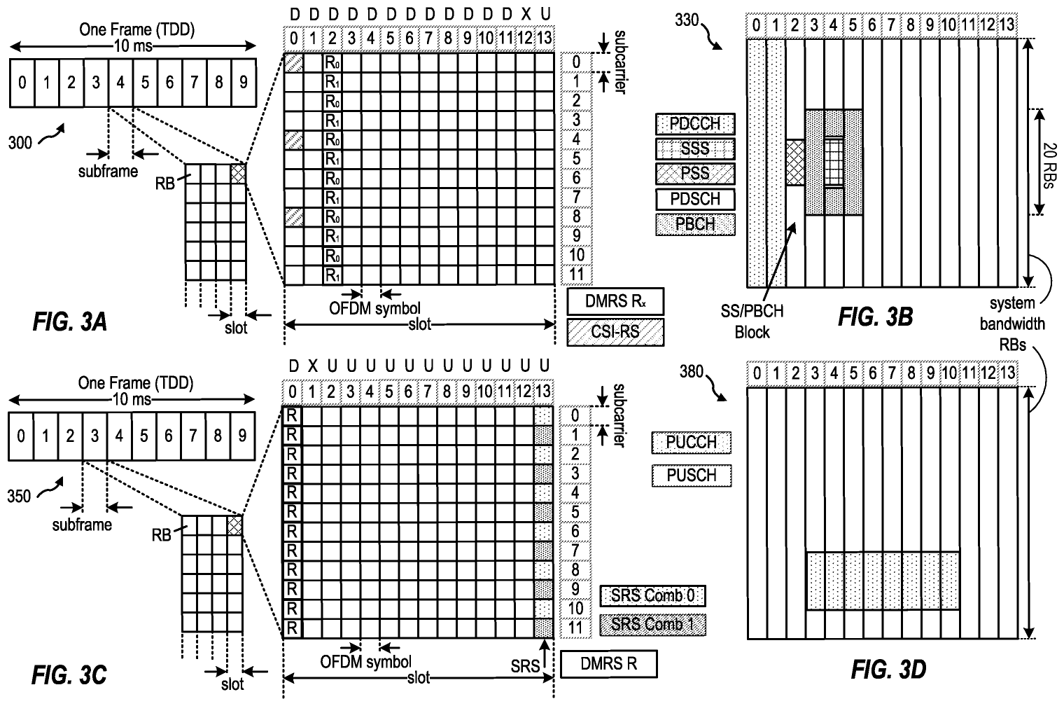

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Example Non-Terrestrial Network

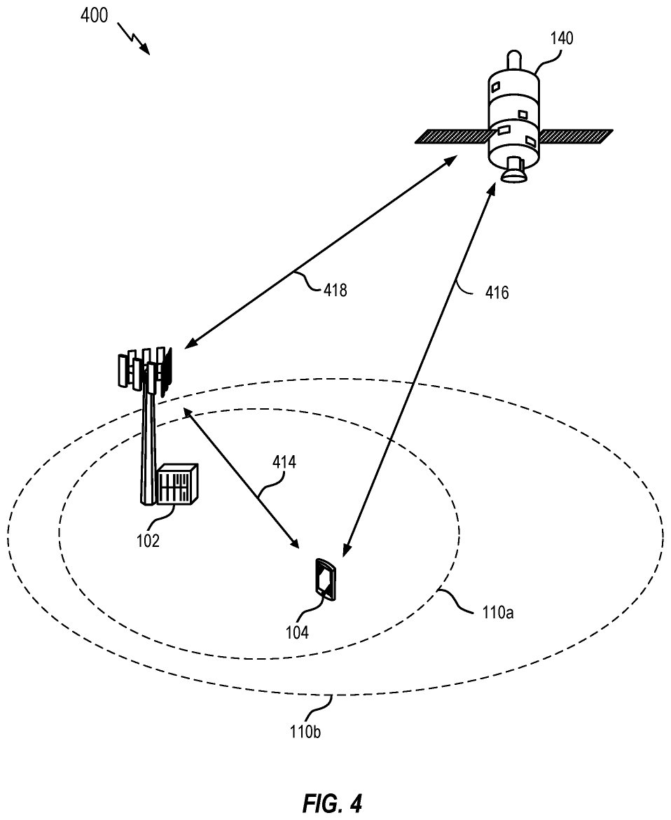

FIG. 4 illustrates an example of a wireless communications network 400 including a non-terrestrial network (NTN) entity 140 (which may be generally referred to as NTN 140), in which aspects of the present disclosure may be practiced. In some examples, the wireless communications network 400 may implement aspects of the wireless communication network 100. For example, the wireless communications network 400 may include BS 102, UE 104, and the non-terrestrial network entity 140, such as a satellite. BS 102 may serve a coverage area (or cell) 110a in cases of a terrestrial network, and non-terrestrial network entity 140 may serve the coverage area 110b in cases of a non-terrestrial network (NTN). Some NTNs may employ airborne platforms (e.g., a drone or balloon) and/or spaceborne platforms (e.g., a satellite).

The non-terrestrial network entity 140 may communicate with the BS 102 and UE 104 as part of wireless communications in an NTN. In cases of a terrestrial network, the UE 104 may communicate with the BS 102 over a communication link 414. In the case of NTN wireless communications, the non-terrestrial network entity 140 may be a serving cell for the UE 104 via a communication link 416. In certain aspects, the non-terrestrial network entity 140 may act as a relay (or a remote radio head) for the BS 102 and the UE 104. For example, the BS 102 may communicate with the non-terrestrial network entity 140 via a communication link 418, and the non-terrestrial network entity may relay signaling between the BS 102 and UE 104 via the communication links 416, 418.

In certain cases, an NTN may provide discontinuous radio coverage to a UE, for example, due to the orbit of NTN satellites. For example, some NTNs (such as a low Earth orbit (LEO) systems) may have one or more revisit times (which may also be known as the response time or coverage gap) in certain geographical areas. The revisit time may be the duration between consecutive viewings (or coverage areas) of a given location for an NTN. As an example, the satellite revisit time (or coverage gap) could be 10 to 40 minutes depending on the number of satellites deployed. The UE may be unreachable by the wireless network (such as the core network) during a revisit time.

FIG. 5 is a diagram illustrating an example NTN 500 having a revisit time 506 between two satellites 502a and 502b. As shown, the UE 104 may be on the edge of the coverage area 110b of the second satellite 502b. The revisit time 506 may provide a coverage gap between the coverage areas 110a, 110b of the satellites 502a, 502b. As the satellites 502a, 502b orbit generally in the respective directions 504a, 504b, the coverage areas 110a, 110b as well as the revisit time 506 pass over the UE 104, such that the UE 104 may experience discontinuous coverage with the NTN 500. As an example, when a UE (e.g., the UE 104) is in a coverage area (e.g., the coverage areas 110a or 110b) of an NTN, the UE may be considered to be in an in-coverage state with the NTN, where the UE can communicate with the NTN. When the UE is in the coverage gap (e.g., the revisit time 506), the UE may be considered to be in an out-of-coverage state with the NTN for a certain duration (e.g., the revisit time), where the UE cannot communicate with the NTN. In some cases, the UE may be considered to be in an in-coverage state with the NTN when the NTN is communicable, whereas the UE may be considered to be in an out-of-coverage state with the NTN when the NTN is noncommunicable.

The revisit time may present various issues in a wireless communication network. For example, when a UE is out-of-coverage with the NTN (e.g., when the UE is in a coverage gap), the wireless network (e.g., the core network) may not be aware of the coverage gap, and the wireless network may attempt to communicate with the UE while the UE is in the coverage gap of the NTN. For example, the core network may attempt to page the UE, and the core network may consider the non-responsiveness of the UE as paging failures. For a mobile terminated call, paging a UE may not be possible during the revisit time. The UE may also perform initial registration or protocol data unit (PDU) establishment procedure when the UE initiates a mobile originated call during the coverage gap. Another issue is that the UE may not recognize the NTN has coverage gap(s) and enter a power saving state (e.g., discontinuous reception (DRX) cycle, power saving mode (PSM), mobile initiated connection only (MICO) mode) during the in-coverage state with the NTN. The UE may also exit the power saving state and attempt to communicate with the NTN during the coverage gap. Such operations during the coverage gap may be inefficient for power consumption, especially at the UE, and/or for signaling overhead (e.g., affecting spectral efficiency) at the radio access network.

To take into account the revisit time, certain wireless networks may provide information related to the discontinuous coverage of an NTN to the UE and/or core network. Such information may enable the UE and/or core network to determine when to expect the coverage gap in the NTN. Certain wireless networks may consider the UE to be powered off or in PSM or MICO during the coverage gap. The wireless network may configure certain power saving state cycles (e.g., DRX cycle and/or PSM cycle) during the coverage gap. The wireless network may adjust the paging window of a DRX cycle to be in the in-overage period of the NTN.

Accordingly, what is needed are techniques and apparatus for paging a UE in discontinuous coverage in an NTN.

### Aspects Related to Paging in Discontinuous Coverage

Aspects of the present disclosure provide techniques and apparatus for paging a UE in discontinuous coverage, for example, due to a coverage gap of an NTN. For example, a base station may receive from a UE or send to a core network paging assistance information that indicates a geographic area in which the UE is located, where the geographic area is in a coverage path of a NTN, for example, as described herein with respect to FIG. 5. The base station or core network may use the paging assistance information to perform various actions to page the UE when the UE is in coverage with the NTN. In certain aspects, the base station and/or core network may delay the paging to the UE until the UE is in coverage with the NTN, as further described herein.

The techniques for paging the UE described herein may enable the network to successfully page a UE in discontinuous coverage, for example, due to the network paging the UE when the UE is in coverage with a cell. The techniques for paging the UE described herein may provide spectral efficiencies, for example, due to the network refraining from paging the UE until the UE is in coverage with a cell.

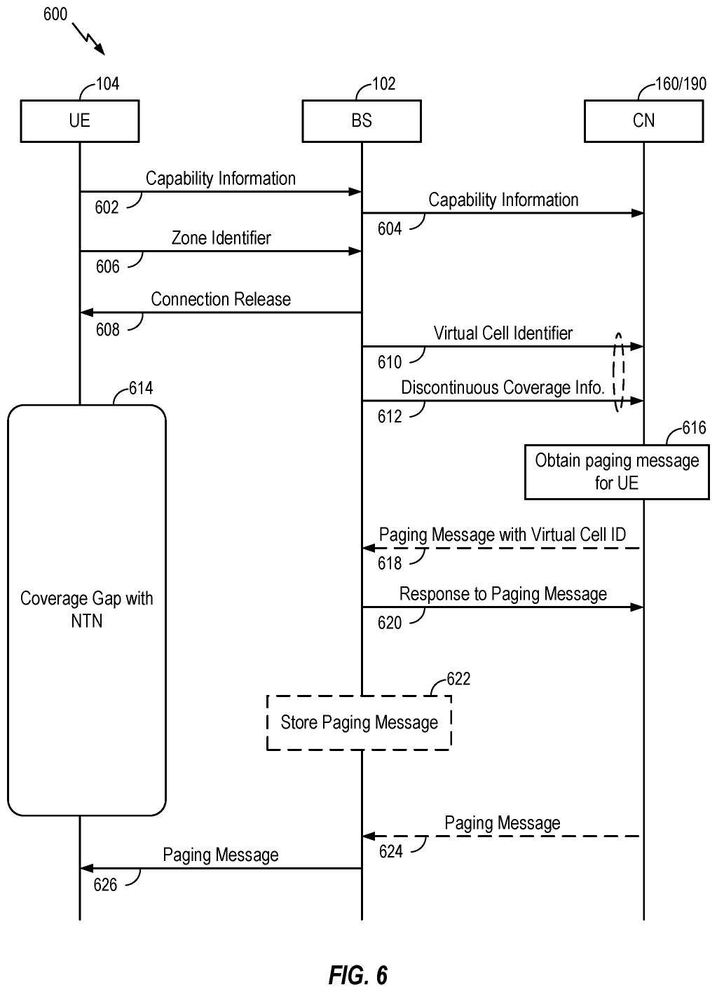

FIG. 6 depicts an example signaling flow 600 for paging a UE in discontinuous coverage, for example, due to a coverage gap of an NTN. In this example, the BS 102 may wirelessly communicate with the UE 104 (e.g., via a Uu interface). Optionally, at step 602, the UE 104 may transmit, to the BS 102, capability information that the UE supports (or is capable of performing) a certain behavior related to the discontinuous coverage, such as that the UE will be in a power saving state during an out-of-coverage state between the UE and a cell (e.g., the NTN) and/or that the UE will be reachable after exiting an out-of-coverage state between the UE and the cell. The capability information may enable the BS 102 and/or core network 160/190 (which may be generally referred to as the CN 190) to page the UE according to the particular behavior(s) indicated by the capability information.

Optionally, at step 604, the BS 102 may provide (e.g., send) the capability information received at step 602 to the CN 190.

In certain aspects, the UE 104 may identify a particular zone identifier associated with the UE's geographic location, and at step 606, the UE 104 may transmit, to the BS 102, an indication of a zone identifier for the UE's geographic location. For certain aspects, the zone identifier may be associated with a particular geographic location, such as a specific region. In certain cases, the zone identifier may include geographic coordinates of the UE. In certain aspects, the zone identifier may include a virtual cell identifier (e.g., a tracking area, a separate cell (group) identifier, or a list of cell identifiers and/or tracking areas) associated with one or more cells having a coverage area in a particular geographic location. For example, the virtual cell identifier may be associated with several NTN satellites providing discontinuous coverage with one or more coverage gaps in a particular geographic region. The zone identifier may enable the BS 102 and/or CN 190 to determine one or more coverage gaps of an NTN for the geographic location of the UE 104. For example, the BS 102 and/or CN 190 may map the zone identifier to a virtual cell identifier associated with the cells providing a coverage area in the geographic location or another identifier associated with multiple cells (e.g., a tracking area, cell group identifier, or a list of cell identifiers), where the geographic location may be subject to discontinuous coverage from an NTN.

At step 608, the BS 102 may transmit, to the UE 104, an indication to release the UE from a connected state (e.g., radio resource control (RRC) connected state). In certain cases, the connection release may be sent before the UE 104 enters the coverage gap to trigger the UE 104 to enter a power saving state. For example, the BS 102 may detect that the UE 104 may be in a coverage gap, and before the UE 104 enters the coverage gap, the BS 102 may send the connection release to the UE 104.

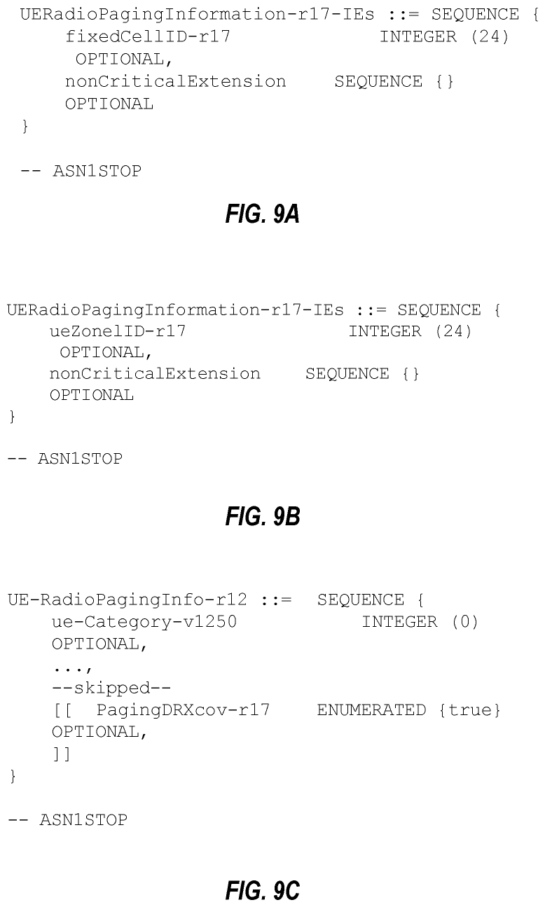

At step 610, the BS 102 may send (e.g., provide, transmit, output for transmission), to the CN 190, an indication of the virtual cell identifier of the cells providing coverage to the UE and/or the zone identifier associated with the UE's geographic location, for example, in response to the connection release being sent at step 608 and/or in response to being aware that the UE 104 is in discontinuous coverage. The virtual cell identifier and/or the zone identifier may be included in an inter-node RRC message, such as an UERadioPagingInformation message or a UEPagingCoverageInformation message, for example, as further described herein with respect FIGS. 9A-9C. In certain cases, the virtual cell identifier and/or zone identifier may implicitly indicate to the CN 190 that the UE 104 is or will be in a coverage gap.

At step 612, the BS 102 may send, to the CN 190, information related to the discontinuous coverage of one or more cells, such as, when and where the coverage gap occurs. For example, the information may indicate when a coverage gap occurs for a particular virtual cell identifier and zone identifier, such as the virtual cell identifier provided at step 610. In certain aspects, the BS 102 may send the virtual cell identifier and/or zone identifier with the discontinuous coverage information for the cells associated with the virtual cell identifier and/or zone identifier.

At step 614, the UE 104 may enter the coverage gap of an NTN, for example, as described herein with respect to FIG. 5. In certain cases, the UE 104 may be unreachable by the radio access network (or the NTN) during the duration of the coverage gap. During the coverage gap, the UE 104 may enter a power saving state (e.g., DRX, PSM, or MICO mode).

At step 616, the CN 190 may obtain a paging message for the UE 104. For example, the CN 190 may receive a notification for an application or a request to establish a call at the UE 104.

Optionally, at step 618, the CN 190 may send, to the BS 102, the paging message or an indication of a paging arrival for the UE 104 with the virtual cell identifier associated with the cells serving the UE and/or the zone identifier associated with the UE's location. The virtual cell identifier and/or zone identifier may enable the BS 102 to identify that the paging message is for cells and/or an area with discontinuous coverage, and the BS 102 may take (e.g., perform) various action(s) in response to the paging message or paging arrival indication with the virtual cell identifier and/or zone identifier, as further described herein.

As an example, at step 620, the BS 102 may send, to the CN 190, a response to the paging message or the paging arrival indication, for example, if the BS 102 is aware that the UE 104 is in the coverage gap and unreachable for paging. The response may indicate: to expect a delay in paging response from the UE 104, a duration of the expected delay or when to send the paging message again following the coverage gap, whether the BS 102 will attempt to page the UE 104 at the next opportunity following the coverage gap, whether the BS 102 will reject the paging message due to the coverage gap. The response may enable the CN 190 to perform certain action(s) in order to successfully page the UE 104.

In certain cases, at step 622, the BS 102 may store the paging message, for example, until the UE is in coverage with a cell, such as an NTN. In certain cases, the BS 102 may store the paging for a certain duration or until a memory buffer reaches a certain usage level (e.g., 80% or 90%) or level of available capacity (e.g., 10% or 20%). Storing the paging message may enable the BS 102 to transmit the paging message to the UE 104, when the UE 104 returns to a coverage area of a cell, such as an NTN. In other words, if memory storage is available, the BS 102 may delay the paging of the UE 104 until the UE 104 exits the coverage gap.

At step 624, the CN 190 may send, to the BS 102, the paging message, for example, in response to the information received at step 604, step 612, and/or step 620. In certain aspects, the CN 190 may delay sending the paging message until the UE 104 is expected to be in coverage with a cell. In other words, the CN 190 may refrain from sending the paging message at step 618 during the coverage gap, for example, based on the information received at step 612, and the CN 190 may send the paging message at step 624 based on when the UE 104 is expected to be in coverage with the cell. In certain cases, the CN 190 may resend the paging message at step 624, for example, in response to the information received at step 620. As an example, if the information at step 620 indicates to expect a delay for a certain duration, the CN 190 may resend the paging message based on the duration of the delay indicated.

At step 626, the BS 102 may transmit, to the UE 104, the paging message after the UE 104 exits the coverage gap, for example, as a delayed at the BS 102 or the CN 190. The timing of the paging message at step 626 may enable the UE 104 to receive the paging message when the UE 104 is reachable in discontinuous coverage, for example, due to the coverage gap of an NTN.

Those of skill in the art will appreciate that signaling flow depicted in FIG. 6 is an example, and other signaling flows may be employed to page a UE in discontinuous coverage. While the example signaling flow in FIG. 6 is described with specific timing (or in a specific sequence) for certain signaling to facilitate understanding (for example, the zone identifier to the CN following the connection release by the BS), aspects of the present disclosure may also be applied to other timing arrangements for the signaling. For example, the BS 102 may send the zone identifier to the CN 190 regardless of whether the BS 102 releases the connection of the UE.

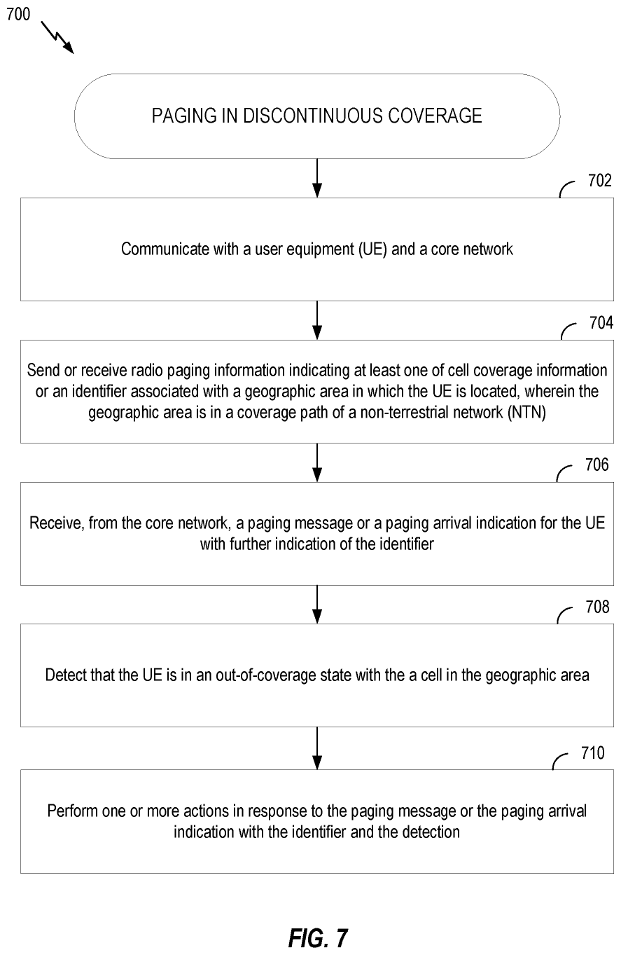

FIG. 7 depicts an example method 700 for paging in discontinuous coverage. The method 700 may optionally begin, at step 702, a network entity (e.g., the BS 102 depicted in FIG. 6) may communicate with a UE (e.g., the UE 104) and a core network (e.g., the CN 190). The network entity may forward traffic between the UE and the core network. For example, the network entity may transmit downlink traffic from the core network to the UE, and in certain cases, the network entity may forward uplink traffic from the UE to the core network. In certain cases, the network entity may communicate with the UE via an NTN, for example, as described herein with respect to FIG. 5. As used herein, a network entity may refer to a (wireless) communication device in a radio access network, such as a base station, a remote radio head or antenna panel in communication with a base station, a non-terrestrial network in communication with a base station, and/or a network controller, which may control multiple base stations and/or radio heads.

At step 704, the network entity may send or receive radio paging information (e.g., paging assistance information) indicating at least one of cell coverage information or an identifier associated with a geographic area in which the UE is located. The geographic area may be in a coverage path of an NTN (e.g., the NTN 140), which may have discontinuous coverage, for example, as depicted in FIG. 5. The NTN may be in a radio access network with the network entity. The network entity may be integrated with and/or co-located with the NTN and/or core network. In certain aspects, the network entity may send, to the core network, the radio paging information at step 704 in response to releasing the UE from a connected state (e.g., RRC connected), for example, to an idle state (e.g., RRC idle). For example, the network entity may send, to the core network, the radio paging information when the UE is released from RRC connected to RRC idle. The network entity may receive the radio paging information at step 704 when the core network initiates a page, for example, with a paging message and/or a paging arrival indication.

Optionally, at step 706, the network entity may receive, from the core network, a paging message or a paging arrival indication for the UE with further indication of the identifier. The identifier may enable the network entity to expect that the UE may be in discontinuous coverage of a cells or an area associated with the identifier.

Optionally, at step 708, the network entity may detect that the UE is in an out-of-coverage state with a cell (e.g., the NTN 140) in the geographic area. For example, the network entity may be aware of the discontinuous coverage for the UE and identify when to expect the UE will be in a coverage gap. In certain aspects, the network entity may detect that the UE is in a coverage gap, for example, due to the absence of responses and/or communications from the UE during coverage gap.

Optionally, at step 710, the network entity may take (e.g., perform) one or more actions in response to the paging message or the paging arrival indication with the identifier and/or the detection. For example, the network entity may delay the paging to the UE and/or respond to the core network with various information related to the discontinuous coverage, as further described herein.

The radio paging information may include an inter-node RRC message sent between a base station and a core network, such as an UERadioPagingInformation message and/or an UEPagingCoverageInformation message, for example as further described herein with respect to FIGS. 9A-9C. The inter-node RRC message (e.g., the UERadioPagingInformation or UEPagingCoverageInformation message) may be extended to include the cell coverage information, zone identifier, and/or virtual cell identifier, described herein.

The cell coverage information may include information related to the discontinuous coverage of certain cells serving the UE. The cell coverage information may indicate when a coverage gap occurs and/or the duration of the coverage gap for a particular geographic area, such as the geographic area in which the UE is located. For certain aspects, the cell coverage information may include an indication of a duration of an out-of-coverage state between the UE and a cell. In certain aspects, the cell coverage information may be associated with the identifier or another identifier mapped to a coverage area or a group of cells (e.g., a tracking area or a separate cell group identifier).

The identifier may include a zone identifier and/or a virtual cell identifier, for example, as described herein with respect to FIG. 6. In certain aspects, a cell identifier and/or tracking area broadcast in system information to a UE may be separate or different from the virtual cell identifier and/or zone identifier. The virtual cell identifier may represent a geographical region where the UE accessed a cell. The virtual cell identifier may be associated with a specific coverage path (such as one or more beams from one or more cells), a coverage path center (e.g., a beam center), a tracking area, and/or a time stamp. With the zone identifier and/or the virtual cell identifier, the network entity may identify the last geographical zone where the UE was located for the purpose of sending paging. In certain aspects, the zone identifier may be independent of the virtual cell identifier, which may be generated by a different RAT, core network, and/or operator than the network entity. The UE may be capable of using geolocation services (e.g., a global navigation satellite system) to identify its location and map the location to a particular zone identifier and/or virtual cell identifier. The zone identifier may be reported to the network entity by the UE, for example, as described herein with respect to FIG. 6, and the network entity may map the zone identifier to a virtual cell identifier.

For certain aspects, the network entity may store the paging message and transmit the paging when the UE is expected to be in coverage with a cell (e.g., an NTN). For example, when the network entity receives paging from core network with paging assistance information (e.g., the virtual cell identifier and/or zone identifier), the network entity may determine the geographic area associated with the virtual cell identifier and/or zone identifier. The network entity may determine that there are no cells (e.g., the satellites supporting the wireless network (public land mobile network) of the network entity) providing coverage in the geographic area. In response to determining that the UE is unreachable, the network entity may store the paging message for transmitting at a later paging occasion. In certain cases, the network entity may page the UE without delay, for example, in case the UE has moved into an area with cell coverage. The network entity may page the UE without delay based on time or beam information. In certain aspects, the network entity may take into account UE mobility information (e.g., stationary UE, low mobility UE, or high mobility UE) and/or the last time the UE accessed the cell in deciding whether to immediately page the UE or delay the paging.

In certain aspects, the network entity may provide various paging assistance information to the core network in response to the paging message and/or paging arrival indication received at step 706. For example, the paging assistance information may include an indication for the core network to expect a delay in a paging response (which may enable the core network to refrain from sending retransmissions and/or escalating the paging behavior), a duration of the expected delay (such as a time window of the coverage gap), recommended cells for paging (e.g., the next cell(s) that will provide coverage to the UE), whether the network entity will refrain from sending the paging, and/or whether the network entity will attempt to page the UE. In certain aspects, the network entity may include the paging assistance information in the radio paging information at step 704. In certain cases, the network entity may exclude redundant information in the response at step 710. As an example, if certain paging assistance information was already provided to the core network at the connection release, redundant information can be avoided in the response at step 710, or a confirmation or update of the paging assistance information can be sent to the core network at step 710. In certain cases, the network entity may provide the paging assistance information in response to the paging message regardless of whether the UE successfully received the page.

As an example, at step 710, the network entity may store the paging message while the UE is in the out-of-coverage state with a cell (e.g., an NTN) and transmit the paging message to the UE when the UE is or expected to be in an in-coverage state with the cell. At step 710, the network entity may send, to the core network, an indication whether the network entity will attempt to send the paging message to the UE when the UE is in the in-coverage state with the NTN; an indication that the UE is in the out-of-coverage state; an indication of one or more cells that are expected to be in communication with the UE when the UE is in an in-coverage state with the NTN; an indication of when the UE is expected to be in an in-coverage state with the NTN; and/or an indication that a cell will refrain from sending the paging message.

According to certain aspects, the network entity may inform the core network that the UE is out of coverage with a cell and allow the core network to handle the subsequent paging behavior or strategy. In certain cases, the network entity may provide the core network with the paging assistance information as described herein. For example, the network entity may indicate the next cell (e.g., satellite) that will provide coverage to the UE, when the UE is expected to be reachable for paging, whether the network entity will store and retry to page the UE, and/or the last time when the UE accessed a cell. With respect to the method 700, the network entity may sending, to the core network, indication of when the UE will be in an in-coverage state with a cell to send a paging message to the UE and/or an indication of when the UE was last in an in-coverage state with a cell.

In certain aspects, the UE may report, to the network entity, capability information related to the discontinuous coverage, such as whether the UE supports paging in discontinuous coverage or whether the UE will be in a power saving state during the coverage gap. For example, the network entity may receive, from the UE, capability information indicating that the UE will be in a power saving state (e.g., DRX, PSM, and/or MICO) during an out-of-coverage state between the UE and a cell (e.g., a satellite of an NTN) and/or indicating that the UE will be reachable after exiting an out-of-coverage state between the UE and a cell. The network entity may transfer the UE capability information to the core network, for example, in a UE-RadioPagingInfo field of the inter-node RRC message. The capability information may enable the network entity and/or core network to take action(s) in accordance with the behavior indicated by the capability information. For example, based on the indication that the UE will be reachable after exiting the out-of-coverage state, the network entity and/or core network may page the UE when the UE is expected to be in coverage with the cell.

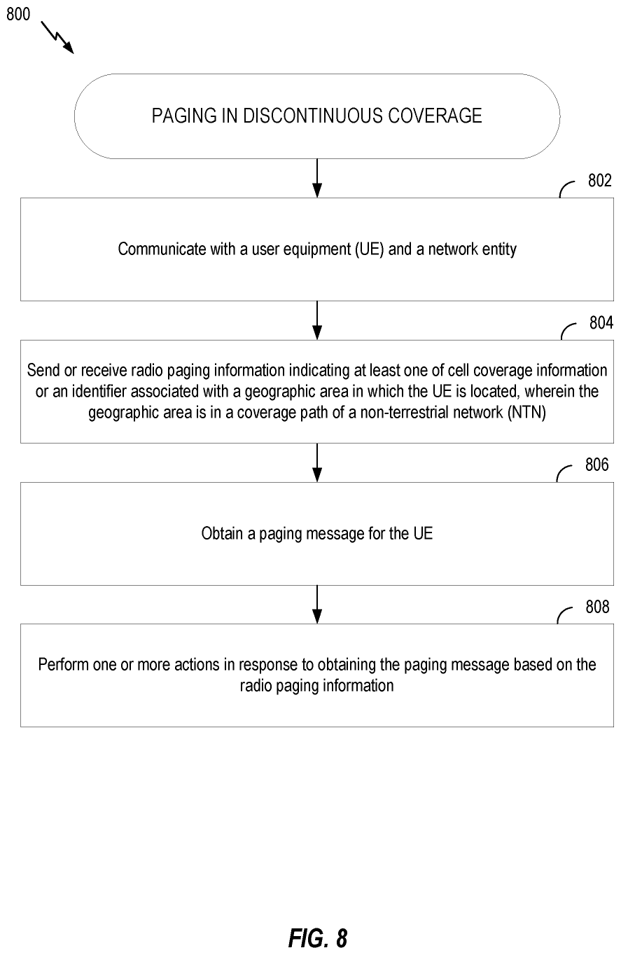

FIG. 8 depicts an example method 800 for paging in discontinuous coverage. The method 800 may optionally begin, at step 802, where a core network (e.g., the core network 190) may communicate with a UE and a network entity (e.g., the base station 102). The core network may transfer downlink data for the UE to the network entity and/or receive uplink data from the UE via the network entity.

At step 804, the core network may send or receive radio paging information indicating at least one of cell coverage information or an identifier associated with a geographic area in which the UE is located. The geographic area may be in a coverage path of a NTN, which may have discontinuous coverage, for example, as depicted in FIG. 5. The radio paging information, cell coverage information, and the identifier may be representative of the aspects described herein with respect FIG. 7. As an example, the core network may receive the radio paging information from the network entity, for example, in response to the network entity releasing a connection with the UE. In certain aspects, the core network may send the radio paging information when the core network initiates a page to the UE, for example, with a paging message and/or a paging arrival indication. The radio paging information may inform the network entity and/or core network that the UE is or will be in discontinuous coverage, for example, due to a coverage gap of an NTN. The radio paging information may provide when and/or where the coverage gap(s) occur, for example, based on the cell coverage information. The radio paging information may indicate the cells and/or geographic region in which the discontinuous coverage may occur, for example, based on a virtual cell identifier and/or zone identifier indicated in the radio paging information.

Optionally, at step 806, the core network may obtain a paging message for the UE. For example, the core network may receive a notification for an application at the UE or a request to setup a call (e.g., video call) between the UE and another UE.

Optionally, at step 808, the core network may take (e.g., perform) one or more actions in response to obtaining the paging message based on the radio paging information and/or detecting that the UE is out of coverage with a cell (e.g., an NTN), for example, as described herein with respect to FIG. 7. As an example, the core network may initiate the paging with the network entity immediately after obtaining the paging message and/or in a delayed manner, for example, due to the discontinuous coverage and/or paging assistance information received from the network entity.

For certain aspects, the core network may determine when the UE is expected to be in coverage with the cell and initiate the paging when the UE is or expected to be in coverage. As an example, the core network may be aware of the discontinuous coverage of cell(s) that may be serving the UE. For example, the core network may be aware of the positions of satellites in an NTN and/or the timing of the coverage gap(s) for the NTN. The core network may take into account the UE's mobility state and/or the paging assistance information received from the network entity in determining when to page the UE and/or which cell(s) to use for the paging. The core network may use the virtual cell identifier and/or the zone identifier in selecting the cell(s) to page the UE. For example, the core network may determine the geographic area associated with a virtual cell identifier and/or zone identifier, and the core network may identify the coverage path of cell(s) and the timing of coverage for the geographic area. The core network may determine how long to postpone paging based on the coverage gap in the identified geographic area. In certain aspects, the core network may request from the network entity and/or a cell to provide the geographic area in which the UE is located.

The core network may initiate and/or delay the paging to the UE based on a coverage state of the cell(s) serving the UE. The core network may detect that the UE is in an out-of-coverage state with a cell (e.g., an NTN) in the geographic area, and the core network may send, to the network entity, the paging message when the UE is expected to be in an in-overage state with the cell in response to the detection. The core network may send paging to other network entities or cells that have coverage (e.g., satellite coverage) in the UE's registered tracking area(s). For certain aspects, the core network may not accept a DRX cycle request from the UE (or a configuration for another type of power saving state), if the requested configuration results in the UE being unreachable during a paging window, for example, due to a coverage gap.

In certain cases, the core network may initiate the paging regardless of the coverage state of the UE with cell(s), and the network entity may facilitate the paging when the UE returns to coverage with a cell, for example, as described herein with respect to FIG. 7. The network entity may delay the paging to the UE and inform the core network of such behavior and/or the paging assistance information, for example, as described herein with respect to FIG. 7. In response to paging assistance information from the network entity, the core network may delay further action(s) (e.g., escalating the paging and/or retransmissions) until the UE is expected to be in coverage with a cell. As an example, at step 808, the core network may send the paging message and/or a paging arrival indication to the network entity with further indication of the identifier. The core network may receive the paging assistance information indicating that the network entity will attempt to page the UE when the UE is expected to be in coverage of a cell. Based on the paging assistance information, the core network may expect the network entity to handle the paging when the UE returns to coverage with the cell. The paging assistance information may enable the core network to refrain from escalating the paging and/or sending additional requests to page the UE. For example, in response to the paging assistance information received from the network entity, the core network may wait to send an additional request to page the UE until the UE is expected to be in coverage as indicated in the paging assistance information. In certain cases, the core network may wait to send an additional request to page the UE until the core network receives, from the network entity, an indication that paging the UE has failed.

According to certain aspects, the core network may initiate the paging, and the core network may receive, from the network entity, an indication that the UE is out of coverage. In response to such an indication, the core network may handle further paging behavior. The network entity may expect the core network to handle the paging strategy after sending the paging assistance informing in response to the paging request from the core network. For example, the core network may resend the paging message for the UE based on the paging assistance information. The core network may resend the paging message to one or more cell indicated in the paging assistance information and/or at time based on the paging assistance information.

In certain aspects, the core network may receive the UE's capability information, for example, as described herein with respect to FIG. 7. The core network may take into account the capability information associated with the UE. For example, the core network may initiate paging after a coverage gap, when the UE will be monitoring for paging as indicated in certain capability information.

FIG. 9A depicts an example UE radio paging information message that includes a fixedCellID field, which may be representative of a virtual cell identifier. The UE radio paging information message may be sent between the core network and network entity. The fixedCellID field may include an integer value indicating a specific virtual cell identifier associated with one or more cells. In certain aspects, the virtual cell identifier may include a list of cell identifiers, tracking areas, or other identifiers associated with one or more cells.

FIG. 9B depicts an example UE radio paging information message that includes a ueZoneID field, which may be representative of a zone identifier. The ueZoneID field may include an integer value associated with a specific geographic area. In certain aspects, the ueZoneID field may include coordinates of the UE's geographic location.

FIG. 9C depicts an example UE radio paging information element that includes a PagingDROXcov field. The UE radio paging information element may be included in an inter-node message to convey the capability information of the UE. The PagingDROXcov field may indicate whether the UE will be reachable after exiting an out-of-coverage state between the UE and a cell (e.g., an NTN). For example, a true state for the PagingDROXcov field may indicate that the UE will be reachable after exiting the out-of-coverage state (e.g., the UE will be monitoring for paging after exiting the out-of-coverage state), whereas a false state may indicate that the UE will not be monitoring for paging by default without further configuration.

Those of skill in the art will understand that the messages and fields illustrated in FIGS. 9A-9C are merely examples. Other messages or fields may be used in addition to or instead of those illustrated to convey the radio paging information and/or capability information described herein.

While the examples depicted in FIGS. 6-9C are described herein with respect to paging in discontinuous coverage due to a coverage gap of an NTN to facilitate understanding, aspects of the present disclosure may also be applied to discontinuous coverage, for example, due to other types of coverage gaps (e.g., coverage gaps associated with drones) or periods where a cell is noncommunicable for wireless communication networks.

### Example Communication Devices

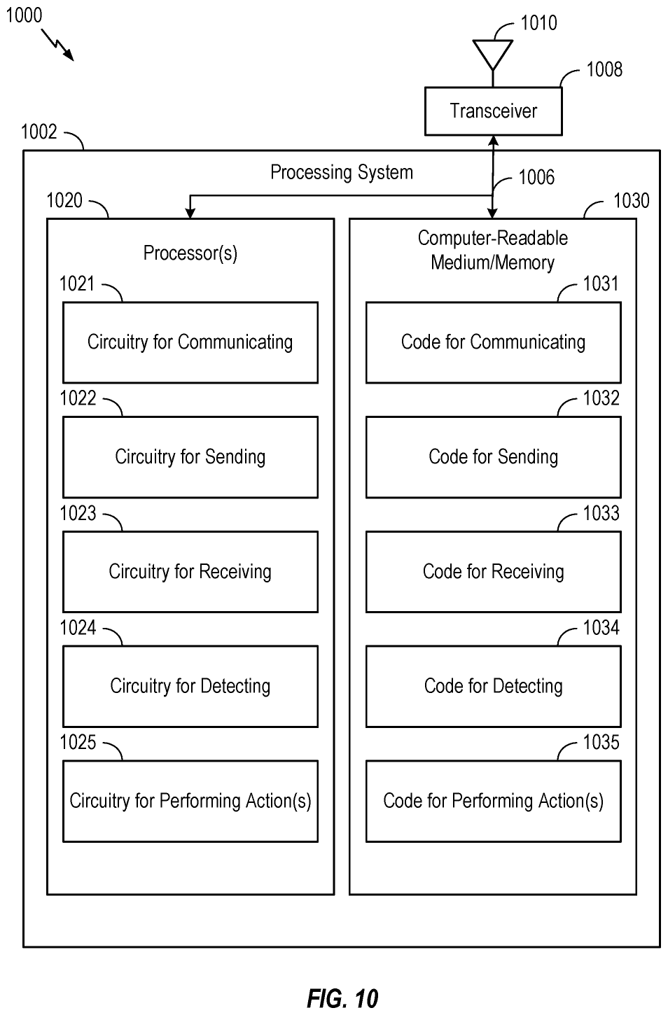

FIG. 10 depicts an example communications device 1000 that includes various components operable, configured, or adapted to perform operations for the techniques disclosed herein, such as the operations depicted and described with respect to FIGS. 6 and 7. In some examples, communication device 1000 may be a base station 102 as described, for example with respect to FIGS. 1 and 2.

Communications device 1000 includes a processing system 1002 coupled to a transceiver 1008 (e.g., a transmitter and/or a receiver). Transceiver 1008 is configured to transmit (or send) and receive signals for the communications device 1000 via an antenna 1010, such as the various signals as described herein. Processing system 1002 may be configured to perform processing functions for communications device 1000, including processing signals received and/or to be transmitted by communications device 1000.

Processing system 1002 includes one or more processors 1020 coupled to a computer-readable medium/memory 1030 via a bus 1006. In certain aspects, computer-readable medium/memory 1030 is configured to store instructions (e.g., computer-executable code) that when executed by the one or more processors 1020, cause the one or more processors 1020 to perform the operations illustrated in FIGS. 6 and 7, or other operations for performing the various techniques discussed herein for paging in discontinuous coverage.

In the depicted example, computer-readable medium/memory 1030 stores code 1031 for communicating (transmitting and/or receiving), code 1032 for sending (transmitting), code 1033 for receiving, code 1034 for detecting, and/or code 1035 for taking action(s).

In the depicted example, the one or more processors 1020 include circuitry configured to implement the code stored in the computer-readable medium/memory 1030, including circuitry 1021 for communicating, circuitry 1022 for sending (or transmitting), circuitry 1023 for receiving, circuitry 1024 for detecting, and/or circuitry 1025 for performing action(s).

Various components of communications device 1000 may provide means for performing the methods described herein, including with respect to FIGS. 6 and 7.

In some examples, means for transmitting or sending (or means for outputting for transmission or means for communicating) may include the transceivers 232 and/or antenna(s) 234 of the base station 102 illustrated in FIG. 2 and/or transceiver 1008 and antenna 1010 of the communication device 1000 in FIG. 10.

In some examples, means for receiving (or means for obtaining or means for communicating) may include the transceivers 232 and/or antenna(s) 234 of the base station illustrated in FIG. 2 and/or transceiver 1008 and antenna 1010 of the communication device 1000 in FIG. 10.

In some examples, means for detecting and/or means for performing (taking) action(s) may include various processing system components, such as: the one or more processors 1020 in FIG. 10, or aspects of the base station 102 depicted in FIG. 2, including receive processor 238, transmit processor 220, TX MIMO processor 230, and/or controller/processor 240 (including the discontinuous coverage component 241).

Notably, FIG. 10 is an example, and many other examples and configurations of communication device 1000 are possible.

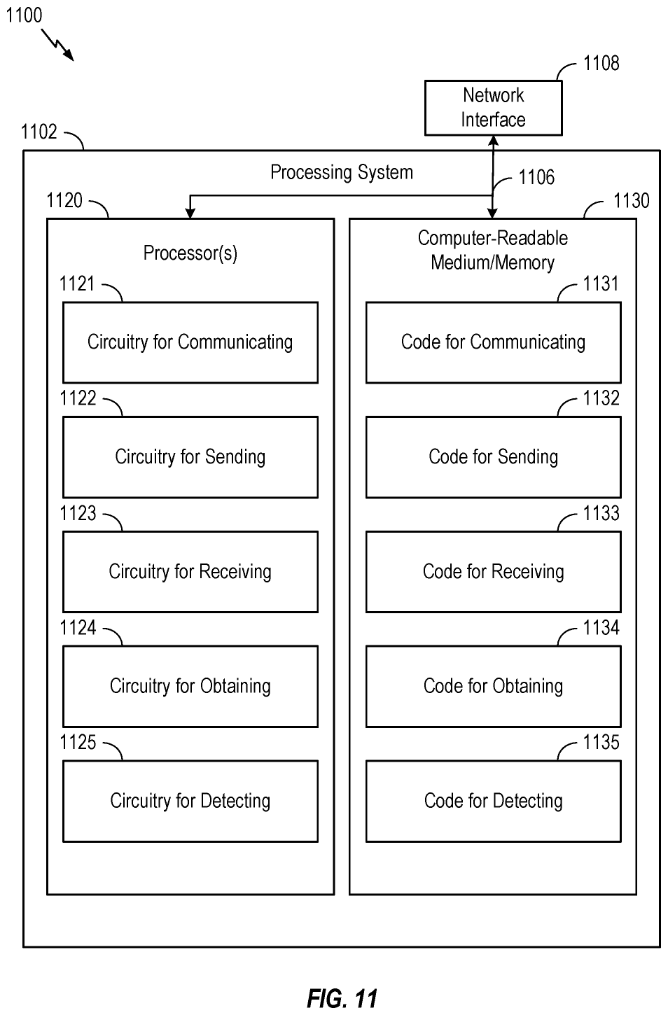

FIG. 11 depicts an example communications device 1100 that includes various components operable, configured, or adapted to perform operations for the techniques disclosed herein, such as the operations depicted and described with respect to FIGS. 6 and 8. In some examples, communication device 1100 may be a core network 160/190 as described, for example with respect to FIGS. 1 and 6.

Communications device 1100 includes a processing system 1102 coupled to a network interface 1108 (e.g., a transmitter and/or a receiver). The network interface 1108 is configured to transmit (or send) and receive signals for the communications device 1100 via a wireless, wired, and/or optical interface, such as the various signals as described herein. As an example, the network interface 1108 may be in communication with one or more base stations, such as the base station 102, via the network interface 1108 through a backhaul link (e.g., the backhaul link 184). Processing system 1102 may be configured to perform processing functions for communications device 1100, including processing signals received and/or to be transmitted by communications device 1100.

Processing system 1102 includes one or more processors 1120 coupled to a computer-readable medium/memory 1130 via a bus 1106. In certain aspects, computer-readable medium/memory 1130 is configured to store instructions (e.g., computer-executable code) that when executed by the one or more processors 1120, cause the one or more processors 1120 to perform the operations illustrated in FIGS. 6 and 8, or other operations for performing the various techniques discussed herein for paging in discontinuous coverage.

In the depicted example, computer-readable medium/memory 1130 stores code 1131 for communicating (transmitting and/or receiving), code 1132 for sending (or transmitting), code 1133 for receiving, code 1134 for obtaining, and/or code 1135 for detecting.

In the depicted example, the one or more processors 1120 include circuitry configured to implement the code stored in the computer-readable medium/memory 1130, including circuitry 1121 for communicating (sending and/or receiving), circuitry 1122 for sending, circuitry 1123 for receiving, circuitry 1124 for obtaining, and/or circuitry 1125 for detecting.

Various components of communications device 1100 may provide means for performing the methods described herein, including with respect to FIGS. 6 and 8.

In some examples, means for transmitting or sending (or means for outputting for transmission or means for communicating) may include the network interface 1108 of the communication device 1100 in FIG. 11.

In some examples, means for receiving (or means for obtaining or means for communicating) may include the network interface 1108 of the communication device 1100 in FIG. 11.

In some examples, means for detecting may include various processing system components, such as the one or more processors 1120 in FIG. 11, which may include the discontinuous coverage component 198.

Notably, FIG. 11 is an example, and many other examples and configurations of communication device 1100 are possible.

### EXAMPLE CLAUSES

Implementation examples are described in the following numbered clauses:

Clause 1: A method of wireless communication by a network entity, comprising: communicating with a user equipment (UE) and a core network; and sending or receiving radio paging information indicating at least one of cell coverage information or an identifier associated with a geographic area in which the UE is located, wherein the geographic area is in a coverage path of a non-terrestrial network (NTN).

Clause 2: The method of Clause 1, wherein sending the radio paging information comprises sending, to the core network, the radio paging information when the UE is released from a connected state.

Clause 3: The method according to any one of Clauses 1 or 2, further comprising: receiving, from the core network, a paging message for the UE or a paging arrival indication for the UE with further indication of the identifier; detecting that the UE is in an out-of-coverage state with a cell in the geographic area; and performing one or more actions in response to the paging message or the paging arrival indication with the identifier and the detection.

Clause 4: The method of Clause 3, wherein performing one or more actions comprises: storing the paging message while the UE is in the out-of-coverage state; and transmitting the paging message to the UE when the UE is in an in-coverage state with the NTN.

Clause 5: The method according to any one of Clauses 3 or 4, wherein performing one or more actions comprise: sending, to the core network, an indication whether the network entity will attempt to send the paging message to the UE when the UE is in the in-coverage state with the NTN.

Clause 6: The method according to any one of Clauses 3-5, wherein performing one or more actions comprise sending, to the core network, an indication that the UE is in the out-of-coverage state.

Clause 7: The method according to any one of Clauses 3-6, wherein performing one or more actions comprise sending, to the core network, an indication of one or more cells that are expected to be in communication with the UE when the UE is in an in-coverage state with the NTN.

Clause 8: The method according to any one of Clauses 3-7, wherein performing one or more actions comprise sending, to the core network, an indication of when the UE is expected to be in an in-coverage state with the NTN.

Clause 9: The method according to any one of Clauses 1-8, wherein the radio paging information includes an indication of a duration of an out-of-coverage state between the UE and a cell.

Clause 10: The method according to any one of Clause 3-9, wherein performing one or more actions comprise sending, to the core network, an indication that a cell will refrain from sending the paging message.

Clause 11: The method according to any one of Clauses 1-10, further comprising sending, to the core network, an indication of when the UE will be in an in-coverage state with a cell to send a paging message to the UE.

Clause 12: The method according to any one of Clause 1-11, further comprising sending, to the core network, an indication of when the UE was last in an in-coverage state with the NTN.

Clause 13: The method according to any one of Clauses 112, further comprising receiving, from the UE, capability information indicating that the UE will be in a power saving state during an out-of-coverage state between the UE and a cell.

Clause 14: The method according to any one of Clause 1-13, further comprising receiving, from the UE, capability information indicating that the UE will be reachable after exiting an out-of-coverage state between the UE and a cell.

Clause 15: A method of communication by a core network, comprising: communicating with a user equipment (UE) and a network entity; and sending or receiving radio paging information indicating at least one of cell coverage information or an identifier associated with a geographic area in which the UE is located, wherein the geographic area is in a coverage path of a non-terrestrial network (NTN).

Clause 16: The method of Clause 15, further comprising: obtaining a paging message for the UE; detecting that the UE is in an out-of-coverage state with a cell in the geographic area; and sending, to the network entity, the paging message when the UE is expected to be in an in-overage state with the cell in response to the detection.

Clause 17: The method according to any one of Clauses 15 or 16, wherein receiving the radio paging information comprises receiving, from a network entity, the radio paging information when the UE is released from a connected state.

Clause 18: The method according to any one of Clauses 15 or 17, further comprising: obtaining a paging message for the UE; and sending, to the network entity, the paging message or a paging arrival indication with further indication of the identifier.

Clause 19: The method of Clause 18, further comprising receiving, from the network entity, an indication whether the network entity will attempt to send the paging message to the UE when the UE is in the in-coverage state with the NTN.

Clause 20: The method according to any one of Clauses 18 or 19, further comprising receiving, from the network entity, an indication that the UE is in the out-of-coverage state.

Clause 21: The method according to any one of Clauses 18-20, further comprising: receiving, from the network entity, an indication of one or more cells that are expected to be in communication with the UE when the UE is in an in-coverage state with the NTN; and sending, to at least one of the one or more cells, the paging message for the UE when the UE is expected to be in the in-coverage state.

Clause 22: The method according to any one of Clauses 18-21, further comprising: receiving, from the network entity, an indication of when the UE is expected to be in an in-coverage state with the NTN; and sending, to the network entity, the paging message for the UE at a time based on the indication.

Clause 23: The method according to any one of Clauses 15, further comprising: sending, to the network entity, a paging message for the UE when the UE is expected to be in an in-coverage state with the NTN based on an indication of a duration of an out-of-coverage state between the UE and a cell, wherein the radio paging information includes the indication.

Clause 24: The method according to any one of Clauses 18-23, further comprising: receiving, from the network entity, an indication that the network entity will refrain from sending the paging message; and sending, to the network entity, the paging message for the UE in response to the indication when the UE is expected to be in an in-coverage state with the NTN.

Clause 25: The method according to any one of Clauses 15-24, further comprising: receiving, from the network entity, information related to the discontinuous coverage of the NTN; and sending the paging message at a time based on the information.

Clause 26: The method according to any one of Clauses 15-25, further comprising: receiving, from the network entity, an indication of when the UE will be in an in-coverage state with a cell; obtaining a paging message for the UE; and sending, to the network entity, the paging message at a time based on the indication.

Clause 27: The method according to any one of Clauses 15-26, further comprising: receiving, from the network entity, an indication of when the UE was last in an in-coverage state with the NTN; and sending, to the network entity, the paging message at a time based on the indication.

Clause 28: The method according to any one of Clauses 15-28, further comprising receiving, from the network entity, capability information for the UE indicating that the UE will be in a power saving state during an out-of-coverage state between the UE and a cell.

Clause 29: The method according to any one of Clauses 15-29, further comprising receiving, from the UE, capability information indicating that the UE will be reachable after exiting an out-of-coverage state between the UE and a cell.

Clause 30: An apparatus, comprising: a memory comprising computer-executable instructions; one or more processors configured to execute the computer-executable instructions and cause the processing system to perform a method in accordance with any one of Clauses 1-29.

Clause 31: An apparatus, comprising means for performing a method in accordance with any one of Clauses 1-29.

Clause 32: A non-transitory computer-readable medium comprising computer-executable instructions that, when executed by one or more processors of a processing system, cause the processing system to perform a method in accordance with any one of Clauses 1-29.

Clause 33: A computer program product embodied on a computer-readable storage medium comprising code for performing a method in accordance with any one of Clauses 1-29.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mm Wave frequencies, the gNB 180 may be referred to as an mm Wave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of communicating with a UE in discontinuous coverage in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication by a network entity, comprising:
communicating with a user equipment (UE) and a core network; and
sending or receiving radio paging information indicating at least one of cell coverage information or an identifier associated with a geographic area in which the UE is located, wherein the geographic area is in a coverage path of a non-terrestrial network (NTN).

2. The method of claim 1, wherein sending the radio paging information comprises sending, to the core network, the radio paging information when the UE is released from a connected state.

3. The method of claim 1, further comprising:
receiving, from the core network, a paging message for the UE or a paging arrival indication for the UE with further indication of the identifier;
detecting that the UE is in an out-of-coverage state with a cell in the geographic area; and
performing one or more actions in response to the paging message or the paging arrival indication with the identifier and the detection.

4. The method of claim 3, wherein performing one or more actions comprises:
storing the paging message while the UE is in the out-of-coverage state; and
transmitting the paging message to the UE when the UE is in an in-coverage state with the NTN.

5. The method of claim 4, wherein performing one or more actions comprise:
sending, to the core network, an indication whether the network entity will attempt to send the paging message to the UE when the UE is in the in-coverage state with the NTN.

6. The method of claim 3, wherein performing one or more actions comprise sending, to the core network, an indication that the UE is in the out-of-coverage state.

7. The method of claim 3, wherein performing one or more actions comprise sending, to the core network, an indication of one or more cells that are expected to be in communication with the UE when the UE is in an in-coverage state with the NTN.

8. The method of claim 3, wherein performing one or more actions comprise sending, to the core network, an indication of when the UE is expected to be in an in-coverage state with the NTN.

9. The method of claim 1, wherein the radio paging information includes an indication of a duration of an out-of-coverage state between the UE and a cell.

10. The method of claim 3, wherein performing one or more actions comprise sending, to the core network, an indication that a cell will refrain from sending the paging message.

11. The method of claim 1, further comprising sending, to the core network, an indication of when the UE will be in an in-coverage state with a cell to send a paging message to the UE.

12. The method of claim 1, further comprising sending, to the core network, an indication of when the UE was last in an in-coverage state with the NTN.

13. The method of claim 1, further comprising receiving, from the UE, capability information indicating that the UE will be in a power saving state during an out-of-coverage state between the UE and a cell.

14. The method of claim 1, further comprising receiving, from the UE, capability information indicating that the UE will be reachable after exiting an out-of-coverage state between the UE and a cell.

15. A method of communication by a core network, comprising:
communicating with a user equipment (UE) and a network entity; and
sending or receiving radio paging information indicating at least one of cell coverage information or an identifier associated with a geographic area in which the UE is located, wherein the geographic area is in a coverage path of a non-terrestrial network (NTN).

16. The method of claim 15, further comprising:
obtaining a paging message for the UE;
detecting that the UE is in an out-of-coverage state with a cell in the geographic area; and
sending, to the network entity, the paging message when the UE is expected to be in an in-overage state with the cell in response to the detection.

17. The method of claim 15, wherein receiving the radio paging information comprises receiving, from a network entity, the radio paging information when the UE is released from a connected state.

18. The method of claim 15, further comprising:
obtaining a paging message for the UE; and
sending, to the network entity, the paging message or a paging arrival indication with further indication of the identifier.

19. The method of claim 18, further comprising receiving, from the network entity, an indication whether the network entity will attempt to send the paging message to the UE when the UE is in an in-coverage state with the NTN.

20. The method of claim 18, further comprising receiving, from the network entity, an indication that the UE is in an out-of-coverage state with the NTN.

21. The method of claim 18, further comprising:
receiving, from the network entity, an indication of one or more cells that are expected to be in communication with the UE when the UE is in an in-coverage state with the NTN; and
sending, to at least one of the one or more cells, the paging message for the UE when the UE is expected to be in the in-coverage state.

22. The method of claim 18, further comprising:
receiving, from the network entity, an indication of when the UE is expected to be in an in-coverage state with the NTN; and
sending, to the network entity, the paging message for the UE at a time based on the indication.

23. The method of claim 15, further comprising:
sending, to the network entity, a paging message for the UE when the UE is expected to be in an in-coverage state with the NTN based on an indication of a duration of an out-of-coverage state between the UE and a cell, wherein the radio paging information includes the indication.

24. The method of claim 18, further comprising:
receiving, from the network entity, an indication that the network entity will refrain from sending the paging message; and
sending, to the network entity, the paging message for the UE in response to the indication when the UE is expected to be in an in-coverage state with the NTN.

25. The method of claim 15, further comprising:
receiving, from the network entity, information related to a discontinuous coverage of the NTN; and
sending a paging message at a time based on the information.

26. The method of claim 15, further comprising:
receiving, from the network entity, an indication of when the UE will be in an in-coverage state with a cell;
obtaining a paging message for the UE; and
sending, to the network entity, the paging message at a time based on the indication.

27. The method of claim 15, further comprising:
receiving, from the network entity, an indication of when the UE was last in an in-coverage state with the NTN; and
sending, to the network entity, a paging message at a time based on the indication.

28. The method of claim 15, further comprising receiving, from the UE, capability information indicating that the UE will be reachable after exiting an out-of-coverage state between the UE and a cell.

29. An apparatus for wireless communication, comprising:
a memory; and
a processor coupled to the memory, the processor and the memory being configured to:
communicate with a user equipment (UE) and a core network; and
send or receive radio paging information indicating at least one of cell coverage information or an identifier associated with a geographic area in which the UE is located, wherein the geographic area is in a coverage path of a non-terrestrial network (NTN).

30. An apparatus for wireless communication, comprising:
a memory; and
a processor coupled to the memory, the processor and the memory being configured to:
communicate with a user equipment (UE) and a network entity; and
send or receive radio paging information indicating at least one of cell coverage information or an identifier associated with a geographic area in which the UE is located, wherein the geographic area is in a coverage path of a non-terrestrial network (NTN).
